(19) United States
(12) Patent Application Publication
(10) Pub. No.: US 2010/0080247 A1
(43) Pub. Date: Apr. 1, 2010

(54) Reassembly of service data units in communications system

(75) Inventors: Tero Miettinen, Oulu (FI); Mika Kaukoranta, Oulu (FI); Antti Tormanen, Oulu (FI); Tommi Kallio, Oulu (FI)

Correspondence Address: SQUIRE, SANDERS & DEMPSEY L.L.P., 8000 TOWERS CRESCENT DRIVE, 14TH FLOOR, VIENNA, VA, 22182-6212, US

(73) Assignee: Nokia Corporation

(21) Appl. No.: 12/318,209

(22) Filed: Dec. 23, 2008

(30) Foreign Application Priority Data
Sep. 30, 2008 (FI) 20085924

(51) Int. Cl. H04J 3/24

(52) U.S. Cl. 370/474

(57) ABSTRACT

The solution relates to reassembling RLC service data units. In the method, received RLC protocol data units in an RLC reception buffer are sequenced according to respective sequence numbers to form a protocol data unit sequence. On the basis of the sequencing, it can be detected if one or more protocol data units are missing from the sequence. If one or more protocol data units are missing, the method comprises checking if the segments for at least one full service data unit are included in the received protocol data units. If the segments for at least one full service data unit are included in the received protocol data units, a reassembly of the at least one full service data unit is executed, and the reassembled service data unit is provided in sequence from the radio link control layer to an upper protocol layer.

### FIELD OF THE INVENTION

The invention relates to data transfer in a communications system, and more particularly to a reassembly of RLC SDUs (radio link control service data unit).

### BACKGROUND OF THE INVENTION

Work on an evolved universal terrestrial radio access network (E-UTRAN), also known as long term evolution (LTE), has been initiated in 3GPP (third generation partnership project) to develop a framework for evolution of the 3GPP radio-access technology towards a high-data-rate, low-latency, packet-optimized radio-access technology with a peak data rate capability of up to 100 Mbps.

A radio link control (RLC) protocol refers to a protocol used at an air interface between a mobile station and a base station. In E-UTRAN, a radio link control (RLC) protocol layer takes care of the buffering and reassembly of DL RLC PDUs (downlink radio link control protocol data unit) and UL RLC PDUs (uplink radio link control protocol data unit) in an RLC acknowledged mode (AM) and RLC unacknowledged mode (UM). The RLC protocol layer of a user terminal buffers RLC PDUs that are not received in sequence from a MAC (media access control) protocol layer of the terminal. In the RLC protocol layer, while waiting for a missing RLC PDU to be received, RLC PDUs are placed in a RLC reception buffer. In practise, there may be a number of RLC PDUs in the RLC reception buffer. When the missing RLC PDU is received, RLC PDUs in the reception buffer are handled, and RLC SDUs are reassembled from RLC PDUs. Reassembled RLC SDU(s) are sent in sequence to an upper protocol layer of the terminal, such as to a packet data convergence protocol (PDCP) layer of the terminal.

Currently, the reassembly is specified to be carried out for RLC SDUs that are included in RLC PDUs received in sequence. If there are one or more missing RLC PDUs, reassembly is not carried out for RLC SDU(s) that are included in RLC PDUs having a sequence number (SN) higher than that of the missing RLC PDU.

A problem associated with the above arrangement is a high peak load when the RLC protocol layer finally reassembles RLC SDU(s) from RLC PDU(s) in the RLC reception buffer. The problem occurs especially when there are many RLC PDUs in the RLC reception buffer waiting for the missing RLC PDU(s) to be received. When the missing RLC PDU(s) is(are) received, many (or even all) of the RLC SDUs included in the RLC PDUs in the reception buffer are reassembled at the same time. This causes a high processing load in the terminal if compared with a situation where there are no RLC PDUs in the RLC reception buffer.

### BRIEF DESCRIPTION OF THE INVENTION

An object of the present invention is thus to provide a method, a system, and an apparatus for implementing the method so as to solve the above problem. The objects of the invention are achieved by a method and an arrangement which are characterized by what is stated in the independent claims. Preferred embodiments of the invention are disclosed in the dependent claims.

The invention is based on the idea of recognizing and reassembling complete RLC service data units in at an RLC protocol layer even if there are missing RLC protocol data units. RLC service data units may be reassembled even if their position in a protocol data unit sequence is later than that of the missing protocol data unit. In the method, protocol data units received from a lower protocol layer are sequenced according to respective sequence numbers to form a protocol data unit sequence. On the basis of said sequencing, it is detected if one or more protocol data units are missing from the protocol data unit sequence. It is checked if each service data unit segment of at least one full service data unit is included in the received protocol data units. If each service data unit segment of at least one full service data unit is included in the received protocol data units, a reassembly of the at least one full service data unit is executed.

An advantage of the method and arrangement of the invention is that as reassembly can be carried out for also RLC SDU(s) included in RLC PDUs with sequence numbers (SN) higher than that of the missing RLC PDU, the overall processing load may be averaged over several transmit time intervals (TTI). This increases layer 2 (L2) data throughput and assists in determining a worst case load in layer 2 processing.

### BRIEF DESCRIPTION OF THE DRAWINGS

In the following the invention will be described in greater detail by means of preferred embodiments with reference to the attached drawings, in which

FIG. 1 is illustrates a communications system according to an embodiment of the present solution;

FIG. 2 illustrates an E-UTRAN user-plane protocol stack;

FIG. 3 is a block diagram illustrating the sequencing and reassembling according to an embodiment of the present solution;

FIG. 4 shows an example of processor load as a function of the transmit time interval;

FIG. 5 illustrates signalling according to an embodiment of the present solution;

FIG. 6 illustrates signalling according to a first embodiment of the present solution;

FIG. 7 illustrates signalling according to a second embodiment of the present solution;

FIG. 8 illustrates signalling according to a third embodiment of the present solution;

FIG. 9 is a flow chart illustrating the functioning of an apparatus according to a first embodiment of the present solution;

FIG. 10 is a flow chart illustrating the functioning of an apparatus according to a second embodiment of the present solution;

FIG. 11 is a flow chart illustrating the functioning of an apparatus according to a third embodiment of the present solution.

### DETAILED DESCRIPTION OF THE INVENTION

In the following, embodiments of the present solution will be described with reference to a cellular mobile communications system, such as an evolved UMTS terrestrial radio access network E-UTRAN. However, the solution is not meant to be restricted to these embodiments. The present solution is applicable to any user terminal, network node, corresponding component(s), and/or to any communication system or any combination of different communication systems capable of utilizing a radio link control protocol. The communication system may be a fixed communication system or a wireless communication system or a communication system utilizing both fixed networks and wireless networks. The protocols used, the specifications of communication systems and network nodes, especially in mobile and wireless communication, develop rapidly. Such development may require extra changes to an embodiment. Therefore, all words and expressions should be interpreted broadly and they are intended to illustrate, not to restrict, the embodiment. The relevant inventive aspect is the functionality concerned, not the network element or equipment where it is executed.

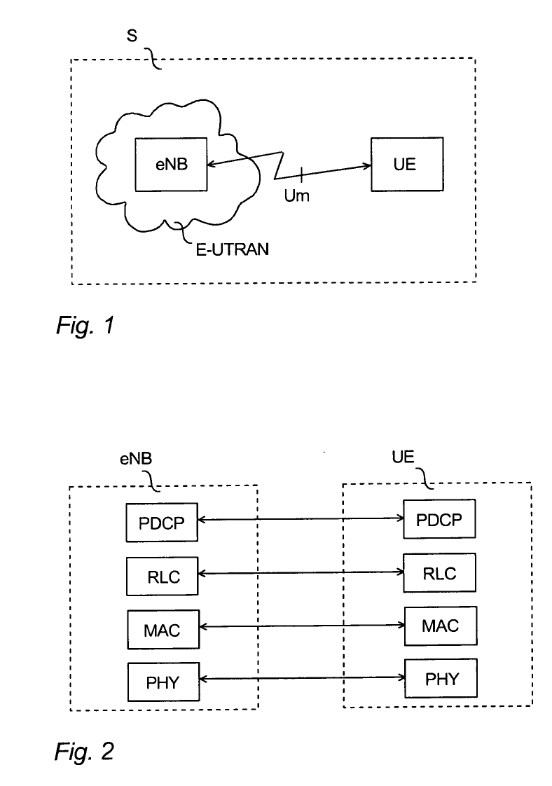

FIG. 1 illustrates a communications system S according to the present solution. Referring to FIG. 1, the system S comprises an apparatus UE that may be e.g. a mobile or wireless user terminal, such as a mobile phone (mobile station), a personal digital assistant (PDA), a game console, a laptop or the like, capable of handling RLC protocol data. The system S further comprises an access network E-UTRAN, such as an evolved UMTS terrestrial radio access network of an enhanced cellular network. Here it is assumed that the user terminal UE is capable of communicating with the network via a network node eNB (E-UTRAN node B) by utilizing an air interface such as a Um radio interface. FIG. 1 shows a simplified version of an evolved UMTS (universal mobile telecommunications system) terrestrial radio access network structure, which illustrates only the components that are essential to illustrate the present solution, even though those skilled in the art naturally know that a general communications system also comprises other functions and structures, which do not have to be described in more detail herein. The network node eNB may include any network element operated by a network operator in an enhanced radio network, such as a base station, access point, radio network controller, database, and/or a network computer or server. Although each network element UE, eNB, E-UTRAN has been depicted as one entity, different modules and memory may be implemented in one or more physical or logical entities. A general architecture of a communication system providing session-based group communication is illustrated in FIG. 1. FIG. 1 is a simplified system architecture only showing some elements and functional entities, all being logical units whose implementation may differ from what is shown. The connections shown in FIG. 1 are logical connections; the actual physical connections may be different. It is apparent to a person skilled in the art that the systems also comprise other functions and structures. It should be appreciated that the functions, structures, elements and the protocols used in or for group communication, are irrelevant to the actual invention. Therefore, they need not to be discussed in more detail here.

FIG. 2 is a block diagram illustrating a protocol stack for an E-UTRAN user plane, where PDCP, RLC and MAC sub-layers (terminated in eNB on the network side) perform functions of the user plane, e.g. header compression, ciphering, and scheduling. On the bottom of the protocol stack, a physical layer is depicted by PHY.

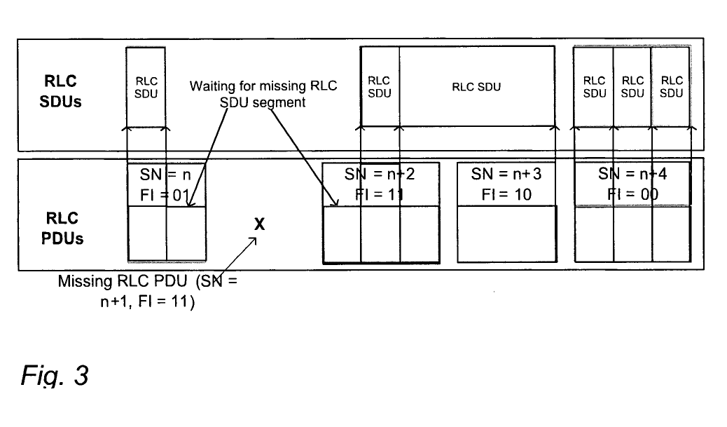

FIG. 3 is a block diagram illustrating the sequencing of received RLC PDUs and reassembling of RLC SDUs according to an embodiment. In E-UTRAN, data is transmitted from a base station to a user terminal as bursts. A new burst may be received e.g. every millisecond, wherein the transmit time interval TTI is 1 ms. The transmit time interval TTI may also be longer or shorter than 1 ms. One burst may include one or more RLC PDUs (also bursts including no RLC PDUs may occur). In the present solution, the received protocol data units RLC PDUs are sequenced in the RLC reception buffer according to their respective sequence numbers to form a protocol data unit sequence. As RLC PDUs are sequenced, it can be detected if one or more RLC PDUs are missing from the protocol data unit sequence. For example, in the situation of FIG. 3, RLC PDUs SN=n, SN=n+2, SN=n+3, and SN=n+4 are in the reception buffer. According to the present solution, an RLC entity in the user terminal UE is thus configured to detect that RLC PDU with SN=n+1 (also indicated with “X”) is missing. According to the present solution it is further configured to check if the service data unit segments of at least one full service data unit RLC SDU are included in the received protocol data units RLC PDU, wherein if each service data unit segment of at least one full service data unit is included in the received protocol data units, the method comprises executing a reassembly of the at least one full service data unit RLC SDU. Reassembling refers to a process where RLC SDU segments included in RLC PDUs are rearranged as RLC SDUs. The order of the RLC SDU segments is the same in RLC SDUs as it is in the sequenced RLC PDUs, but RLC SDU segments included in the same RLC PDU are not necessarily included in the same RLC SDU, and vice versa. In the situation of FIG. 3, six full RLC SDUs can be reassembled, while “incomplete” RLC SDUs in SN=n PDU and SN=n+2 PDU remain “non-reassembled” in the reception buffer, waiting for missing RLC SDU segments. Thus, FIG. 3 depicts the present solution how some of the RLC SDUs can be reassembled before a missing RLC PDU (like RLC PDU with SN=n+1 in FIG. 3) is received. Procedures to be executed during reassembly include checking if reassembly is needed and carrying out the reassembly. Checking if reassembly is needed means that the RLC PDU sequence number SN and RLC PDU framing info FI values are checked in order to find out if one or more full RLC SDUs can be formed from different RLC PDUs in the reception buffer. If at least one full RLC SDU can be formed, then the reassembly of respective RLC SDU is carried out. FI value 00 means that the first and the last related RLC SDU are completely included in the respective RLC PDU (as RLC PDU with SN=n+4 in FIG. 3). FI value 01 means that the first related RLC SDU is completely included in the respective RLC PDU, whereas the last related RLC SDU is incompletely included in the respective RLC PDU (as RLC PDU with SN=n in FIG. 3). FI value 10 means that the first related RLC SDU is incompletely included in the respective RLC PDU, whereas the last related RLC SDU is completely included in the respective RLC PDU (as RLC PDU with SN=n+3 in FIG. 3). FI value 11 means that the first and the last related RLC SDU are incompletely included in the respective RLC PDU (as RLC PDUs with SN=n+1 and SN=n+2 in FIG. 3).

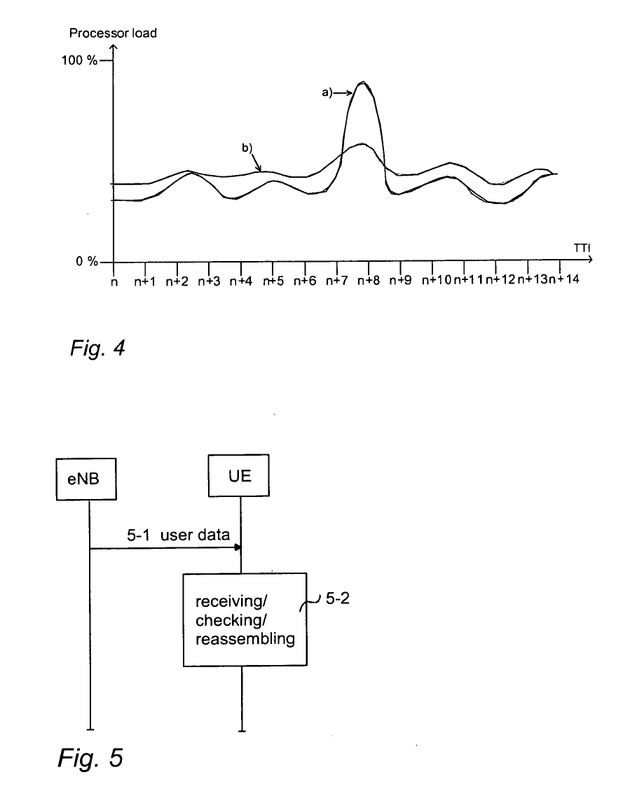

FIG. 4 shows an example of the processor load as a function of the transmit time interval TTI when reassembling RLC SDUs. In FIG. 4, in TTI=n+7, a missing RLC PDU is received and in-sequence delivery of data in RLC reception buffer to an upper protocol layer may be carried out. Line a) depicts a prior art method where reassembly is carried out for all RLC PDUs in RLC reception buffer at the same time in TTI=n+7 when receiving the missing RLC PDU(s). Line b) depicts the method according to an embodiment of the present solution where reassembly of RLC SDUs is carried out even if there are missing RLC PDUs. As can be seen from FIG. 4, there occurs a high peak load at TTI=n+7 when the prior art method is used. When using the present solution, the processor load can be balanced so that high peak loads can be significantly reduced.

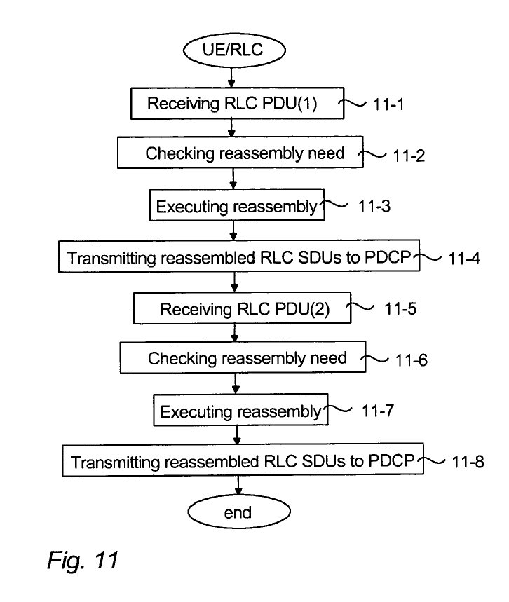

FIG. 5 illustrates signalling between network elements according to the present solution. Referring to FIG. 5, the apparatus UE (such as a user terminal) receives, in step 5-2, user data 5-1 transmitted from the network node eNB (such as a base station). In response to receiving the message 5-1, respective DL RLC PDUs are provided 5-2 from the MAC protocol layer to the RLC protocol layer of the user terminal. The received protocol data units are arranged in order based on the PDU sequence numbers. Based on that, it can be detected 5-2 if one or more protocol data units are missing from a protocol data unit sequence. If one or more protocol data units are missing, it is checked 5-2 if the RLC SDU segments of at least one full service data unit are included in the received protocol data units. If each RLC SDU segment of at least one full service data unit is included in the received protocol data units, the method comprises executing 5-2 a reassembly of the at least one full service data unit. As the missing RLC PDU is received, reassembled RLC SDUs are provided in sequence from the radio link control protocol layer to an upper protocol layer (e.g. PDCP) in the apparatus UE (not shown in FIG. 5). The term “in sequence” means that if there are missing RLC PDUs, reassembled RLC SDUs with a lower sequence number than that of the missing RLC PDU, can be delivered to the upper protocol layer. However, it is optional to deliver RLC SDU(s) to the upper layer right after a first RLC SDU reassembly. In that case it/they may be delivered to the upper layer e.g. in step 11-8 (as described below in connection with FIG. 11).

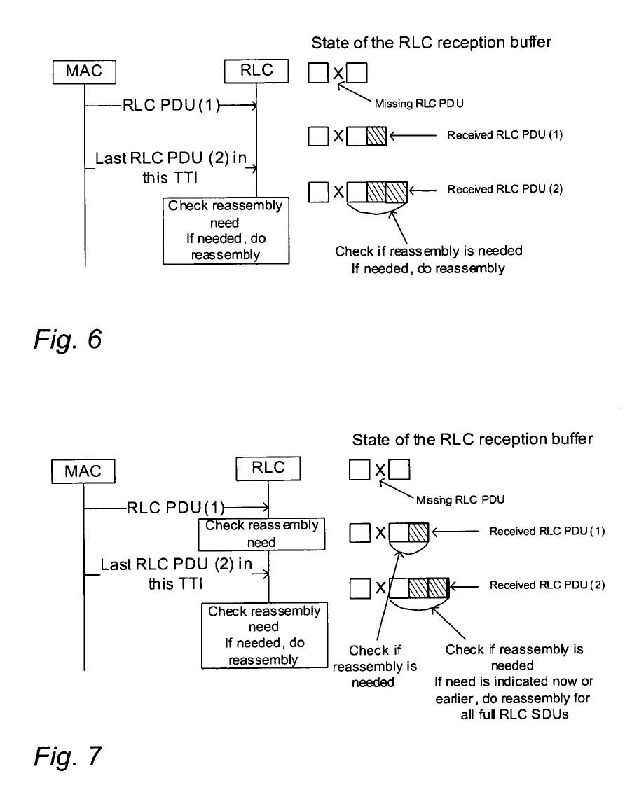

FIG. 6 illustrates signalling between the MAC protocol layer and the RLC protocol layer of the user terminal UE according to a first embodiment of the present solution. FIG. 6 depicts reassembly of RLC SDUs according to the first embodiment, illustrating also the state of the RLC reception buffer. For each TTI, it is checked if the RLC PDU(s) (RLC PDU(1), RLC PDU(2); striped squares) received at the RLC protocol layer in this TTI can form one or more full RLC SDUs with or without the RLC PDU(s) (illustrated by blank squares) in the RLC reception buffer. If one or more full RLC SDUs can be formed, reassembly of the RLC SDU(s) is executed. In the first embodiment, reassembly of the RLC SDU(s) is carried out once per each transmit time interval (TTI). A missing RLC PDU is illustrated by “X”.

FIG. 7 illustrates signalling between the MAC protocol layer and the RLC protocol layer of the user terminal UE according to a second embodiment of the present solution. FIG. 7 depicts reassembly of RLC SDUs according to the second embodiment, illustrating also the state of the RLC reception buffer. For each received RLC PDU (RLC PDU(1), RLC PDU(2); striped squares), it is checked if the received RLC PDU can form a full RLC SDU(s) with or without the RLC PDU(s) (illustrated by blank squares) in the RLC reception buffer. If full RLC SDU(s) can be formed, reassembly of the RLC SDU(s) is executed once per each transmit time interval (TTI). A missing RLC PDU is illustrated by “X”.

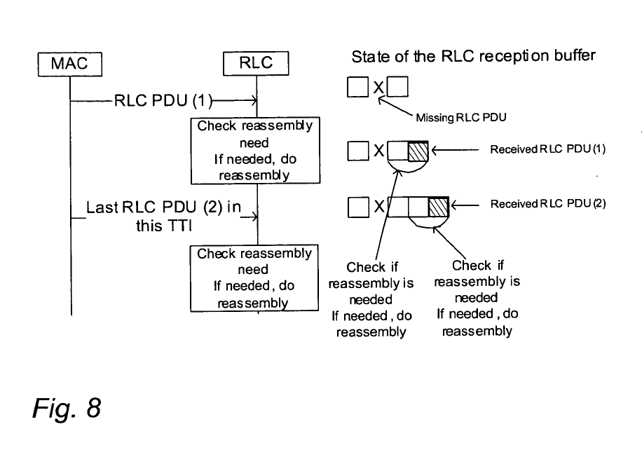

FIG. 8 illustrates signalling between the MAC protocol layer and the RLC protocol layer of the user terminal UE according to a third embodiment of the present solution. FIG. 8 depicts reassembly of RLC SDUs according to the third embodiment, illustrating also the state of the RLC reception buffer. For each received RLC PDU (RLC PDU(1), RLC PDU(2); striped squares), it is checked if the received RLC PDU can form a full RLC SDU(s) with or without the RLC PDU(s) (illustrated by blank squares) in the RLC reception buffer. If full RLC SDU(s) can be formed, reassembly of the RLC SDU(s) is executed immediately. A missing RLC PDU is illustrated by “X”.

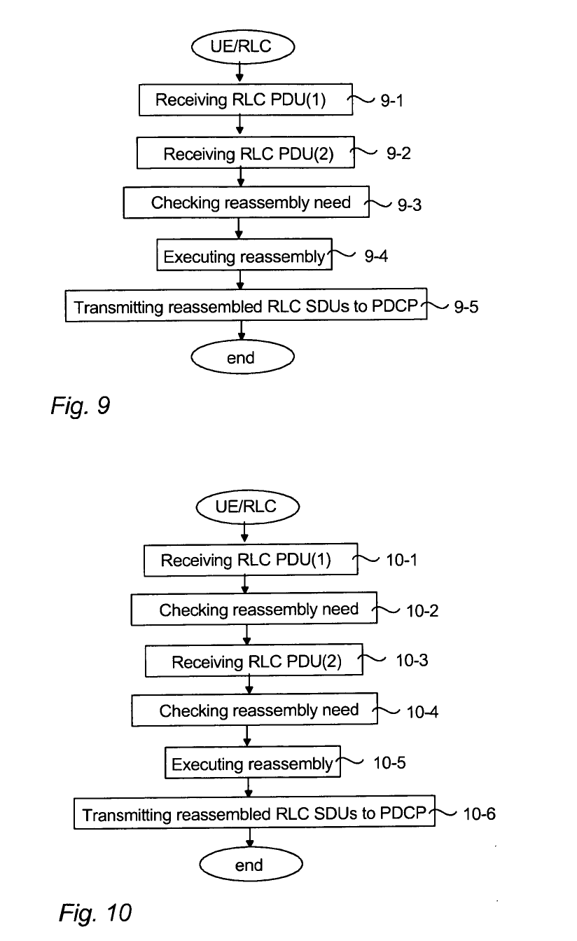

FIG. 9 is a flow chart illustrating the functioning of an RLC protocol layer of an apparatus such as a user terminal UE according to a first embodiment of the present solution. In step 9-1, UE/RLC receives a first packet RLC PDU(1) in a certain TTI from the MAC protocol layer. In step 9-2, UE/RLC receives the last packet RLC PDU(2) in said TTI from the MAC protocol layer. The received protocol data units are arranged 9-3 in order based on PDU sequence numbers. Based on that, it can be detected 9-3 if one or more protocol data units are missing from a protocol data unit sequence. Further in step 9-3, it is checked if the RLC PDU(s) (RLC PDU(1), RLC PDU(2)) received at the RLC protocol layer in this TTI are able to form one or more full RLC SDUs with or without RLC PDU(s) in a RLC reception buffer. If one or more full RLC SDUs can be formed, reassembly of the RLC SDU(s) is executed in step 9-4. In the first embodiment, reassembly of the RLC SDU(s) is carried out once per each transmit time interval (TTI). In step 9-5, reassembled RLC SDUs are provided in sequence from the radio link control protocol layer to an upper protocol layer (e.g. PDCP) in the apparatus UE.

FIG. 10 is a flow chart illustrating the functioning of an RLC protocol layer of an apparatus such as a user terminal UE according to a second embodiment of the present solution. In step 10-1, UE/RLC receives a first packet RLC PDU(1) in a certain TTI from the MAC protocol layer. For the received RLC PDU (RLC PDU(1)), it is checked 10-2 if it can form a full RLC SDU(s) with or without the RLC PDU(s) in the RLC reception buffer. In step 10-3, UE/RLC receives the last packet RLC PDU(2) in said TTI from the MAC protocol layer. For the received RLC PDU (RLC PDU(2)), it is checked 10-4 if it can form a full RLC SDU(s) with or without the RLC PDU(s) in the RLC reception buffer. In the second embodiment, if it is detected in step 10-2 and/or 10-4 that one or more full RLC SDUs can be formed, reassembly of the one or more RLC SDUs is executed 10-5 once per said transmit time interval (TTI). In steps 10-2 and 10-4, the received protocol data units are arranged in order based on PDU sequence numbers. Based on that, it can be detected 10-2, 10-4 if one or more protocol data units are missing from a protocol data unit sequence. In step 10-6, reassembled RLC SDUs are provided in sequence from the radio link control protocol layer to an upper protocol layer (e.g. PDCP) in the apparatus UE.

FIG. 11 is a flow chart illustrating the functioning of an RLC protocol layer of an apparatus such as a user terminal UE according to a third embodiment of the present solution. In step 11-1, UE/RLC receives a first packet RLC PDU(1) in a certain TTI from the MAC protocol layer. For the received RLC PDU (RLC PDU(1)), it is checked 11-2 if it can form a full RLC SDU(s) with or without the RLC PDU(s) in the RLC reception buffer. If it is detected 11-2 that one or more full RLC SDU(s) can be formed, reassembly of said one or more RLC SDUs is executed 11-3 immediately. In step 11-4, reassembled RLC SDUs are provided in sequence from the radio link control protocol layer to an upper protocol layer (e.g. PDCP) in the apparatus UE. In step 11-5, UE/RLC receives the last packet RLC PDU(2) in said TTI from the MAC protocol layer. For the received RLC PDU (RLC PDU(2)), it is checked 11-6 if it can form a full RLC SDU(s) with or without the RLC PDU(s) in the RLC reception buffer. If it is detected in step 11-6 that one or more full RLC SDU(s) can be formed, reassembly of said one or more RLC SDUs is executed immediately in step 11-7. In step 11-8, reassembled RLC SDUs are provided in sequence from the radio link control protocol layer to an upper protocol layer (e.g. PDCP) in the apparatus UE. In steps 11-2 and 11-6, the received protocol data units are arranged in order based on PDU sequence numbers. Based on that, it can be detected 11-2, 11-6 if one or more protocol data units are missing from a protocol data unit sequence.

The present solution enables an in-advance reassembly of fully received RLC SDUs before in-sequence delivery to an upper protocol layer such as PDCP. By means of the present solution, reassembly of RLC SDUs is possible before receiving every RLC PDU in sequence. When the missing RLC PDU is received, only a small part of the RLC SDU(s) in the RLC reception buffer needs to be reassembled (those requiring the data from the missing RLC PDU(s) in order to complete RLC SDU(s)). Reassembled RLC SDUs are delivered in sequence to an upper protocol layer, i.e. reassembled RLC SDUs (whose RLC PDU sequence number is higher than that of a missing RLC PDU) are maintained in RLC protocol layer until the missing RLC PDU is received. The delivery to the upper protocol layer(s) is carried out as the missing RLC PDU is received and reassembly carried out for related RLC SDU segments.

It should be noted that the present solution is also applicable to uplink data transfer where user data is received e.g. in a network node eNB from a user terminal UE. Thus, instead of or in addition to a user terminal UE, the present solution where RLC PDUs are received and RLC SDUs reassembled/delivered, may be carried out, for example, in a network node eNB (such as a base station).

The items and steps shown in the figures are simplified and only aim at describing the idea of the present solution. Other items may be used and/or other functions carried out between the steps. The items serve only as examples and they may contain only some of the information mentioned above. The items may also include other information, and the titles may deviate from those given above. The order of the items and/or steps may deviate from the given ones. Instead of or in addition to a base station, and/or user terminal, the above-described operations may be performed in any other element of a communications system.

In addition to prior art means, a system or system network nodes that implement the functionality of the present solution comprise means for processing user data in a manner described above. Existing network nodes and user terminals comprise processors and memory that can be utilized in the operations of the present solution. Any changes needed in implementing the present solution may be carried out using supplements or updates of software routines and/or routines included in application-specific integrated circuits (ASIC) and/or programmable circuits, such as EPLDs (electrically programmable logic device) or FPGAs (field programmable gate array).

It will be obvious to a person skilled in the art that, as the technology advances, the inventive concept can be implemented in various ways. The invention and its embodiments are not limited to the examples described above but may vary within the scope of the claims.

### LIST OF ABBREVIATIONS:

AM=acknowledged mode

UM=unacknowledged mode

RLC=radio link control

PDU=protocol data unit

PDCP=packet data convergence protocol

SDU=service data unit

TTI=transmit time interval

SN=sequence number

FI=framing info

L2=layer 2

We claim:

1. A method of processing user data in a communications system comprising an apparatus capable of receiving protocol data units at a radio link control layer from a lower protocol, the method comprising
sequencing received protocol data units in a reception buffer according to respective sequence numbers;
detecting, if one or more protocol data units are missing from a protocol data unit sequence; and
checking if each service data unit segment of at least one full service data unit is included in the received protocol data units;
wherein, if each service data unit segment of at least one full service data unit is included in the received protocol data units, the method comprises executing a reassembly of the at least one full service data unit.

2. A method as claimed in claim 1, wherein the method comprises
sequencing received protocol data units in a reception buffer according to respective sequence numbers to form a protocol data unit sequence; and
detecting, on the basis of said sequencing, if one or more protocol data units are missing from the protocol data unit sequence;
wherein, if one or more protocol data units are missing, the method comprises
checking if each service data unit segment of at least one full service data unit is included in the received protocol data units;
wherein, if each service data unit segment of at least one full service data unit is included in the received protocol data units, the method comprises
executing a reassembly of the at least one full service data unit.

3. A method as claimed in claim 1, wherein the checking, if each service data unit segment of at least one full service data unit is included in the received protocol data units, is carried out once per each transmit time interval.

4. A method as claimed in claim 1, wherein the checking, if each service data unit segment of at least one full service data unit is included in the received protocol data units, is carried out once per each received protocol data unit.

5. A method as claimed in claim 3, wherein the executing of the reassembly of the at least one full service data unit is carried out once per each transmit time interval.

6. A method as claimed in claim 4, wherein the executing of the reassembly of the at least one full service data unit is carried out once per each received protocol data unit.

7. A method as claimed in claim 1, wherein the method comprises detecting, on the basis of framing info of the protocol data unit preceding and/or succeeding the missing protocol data unit, whether or not one or more service data unit segments related to a service data unit are included in the missing protocol data unit.

8. A method as claimed in claim 1, wherein the method comprises performing a reassembly of the at least one full service data unit before the missing protocol data unit is received.

9. A method as claimed in claim 1, wherein reassembled service data units are delivered in sequence from the radio link control layer to an upper layer.

10. A method as claimed in claim 1, wherein the transmit time interval is 1 ms.

11. A method as claimed in claim 1, wherein the method comprises balancing a processing load in the system over several transmit time intervals.

12. A method as claimed in claim 1, wherein the method comprises carrying out a reassembly of a service data unit related to a protocol data unit having a higher sequence number than that of the missing protocol data unit.

13. A method as claimed in claim 1, wherein the method comprises carrying out a reassembly of a service data unit related to protocol data units having higher and lower sequence numbers than that of the missing protocol data unit.

14. A method as claimed in claim 1, wherein the method steps are performed in a downlink radio link control entity of a user terminal.

15. A method as claimed in any of claims 1, wherein the method steps are performed in an uplink radio link control entity of a base station.

16. A communications system comprising an apparatus capable of receiving protocol data units at a radio link control layer from a lower protocol layer, wherein the system is configured to
sequence received protocol data units according to respective sequence numbers;
detect, on the basis of said sequencing, if one or more protocol data units are missing from a protocol data unit sequence; and
check if each service data unit segment of at least one full service data unit is included in the received protocol data units;
wherein, if each service data unit segment of at least one full service data unit is included in the received protocol data units, the system is configured to execute the reassembly of the at least one full service data unit.

17. An apparatus capable of receiving protocol data units at a radio link control layer from a lower protocol layer, wherein the apparatus is configured to
sequence received protocol data units according to respective sequence numbers;
detect, on the basis of said sequencing, if one or more protocol data units are missing from a protocol data unit sequence; and
check, if each service data unit segment of at least one full service data unit is included in the received protocol data units;
wherein, if each service data unit segment of at least one full service data unit is included in the received protocol data units, the apparatus is configured to execute the reassembly of the at least one full service data unit.

18. An apparatus as claimed in claim 17, wherein it is configured to
sequence received protocol data units in a reception buffer according to respective sequence numbers to form a protocol data unit sequence; and
detect, on the basis of said sequencing, if one or more protocol data units are missing from the protocol data unit sequence;
wherein, if one or more protocol data units are missing, the apparatus is configured to
check if each service data unit segment of at least one full service data unit is included in the received protocol data units;
wherein, if each service data unit segment of at least one full service data unit is included in the received protocol data units, the apparatus is configured to
execute the reassembly of the at least one full service data unit.

19. An apparatus as claimed in claim 17, wherein it is configured to carry out the checking, if each service data unit segment of at least one full service data unit is included in the received protocol data units, once per each transmit time interval.

20. An apparatus as claimed in claim 17, wherein it is configured to carry out the checking, if each service data unit segment of at least one full service data unit is included in the received protocol data units, once per each received protocol data unit.

21. An apparatus as claimed in claim 19, wherein it is configured to execute the reassembly of the at least one full service data unit once per each transmit time interval.

22. An apparatus as claimed in claim 20, wherein it is configured to execute the reassembly of the at least one full service data unit once per each received protocol data unit.

23. An apparatus as claimed in claim 17, wherein it is configured to detect, on the basis of framing info of the protocol data unit preceding and/or succeeding the missing protocol data unit, whether or not one or more service data unit segments related to a service data unit are included in the missing protocol data unit.

24. An apparatus as claimed in claim 17, wherein it is configured to perform a reassembly of the at least one full service data unit before the missing protocol data unit is received.

25. An apparatus as claimed in claim 17, wherein it is configured to deliver reassembled service data units in sequence from the radio link control layer to an upper layer.

26. An apparatus as claimed in claim 17, wherein it is configured to carry out a reassembly of a service data unit related to a protocol data unit having a higher sequence number than that of the missing protocol data unit.

27. An apparatus as claimed in claim 17, wherein it is configured to carry out a reassembly of a service data unit related to protocol data units having higher and lower sequence numbers than that of the missing protocol data unit.

28. An apparatus as claimed in claim 17, wherein it is a user terminal.

29. An apparatus as claimed in claim 17, wherein it is a base station.
